(19) United States
(12) Patent Application Publication
(10) Pub. No.: US 2014/0286841 A1
(43) Pub. Date: Sep. 25, 2014

(54) PROCESSES FOR RECOVERING RARE EARTH ELEMENTS FOR ALUMINUM-BEARING MATERIALS

(71) Applicants: Richard Boudreault, St-Laurent (CA); Joël Fournier, Carignan (CA); Laury Gauthier, Saint-Apollinaire (CA)

(72) Inventors: Richard Boudreault, St-Laurent (CA); Joël Fournier, Carignan (CA); Laury Gauthier, Saint-Apollinaire (CA)

(73) Assignee: ORBITE ALUMINAE INC., St-Laurent, QC (CA)

(21) Appl. No.: 14/233,819

(22) PCT Filed: Jul. 18, 2012
(86) PCT No.: PCT/CA2012/000687

§ 371 Date: Apr. 4, 2014

Related U.S. Application Data
(60) Provisional application No. 61/508,950, filed on Jul. 18, 2011.

(51) Int. Cl. C01G 49/02; C22B 21/00

(52) U.S. Cl. CPC C01G 49/02; C22B 21/0015
USPC 423/127; 423/122; 423/140

(57) ABSTRACT

There are provided methods for separating iron ions from aluminum ions contained in an acidic composition. The methods comprise reacting the acidic composition with a basic aqueous composition having a pH of at least 10.5 so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion; and separating the liquid portion from the solid portion. There are also provided methods for treating an acidic composition comprising iron ions and aluminum ions. Such methods can be useful for preparing products such as alumina, aluminum, hematite etc.

### CROSS-REFERENCE TO RELATED APPLICATIONS

The present application claims priority on U.S. 61/508,950 filed on Jul. 18, 2011, that is hereby incorporated by reference in its entirety.

### TECHNICAL FIELD

The present disclosure relates to improvements in the field of chemistry applied to the synthesis and/or separation of iron-bearing products and/or aluminum-bearing products. For example, such methods are useful for separating iron ions and aluminum ions contained in a same composition. For example, the methods can also be useful for treating an acidic composition comprising aluminum ions and iron ions.

### BACKGROUND OF THE DISCLOSURE

Iron ions can be difficult to remove from certain ores. For example, extracting aluminum ions from certain material (such as red mud) or certain ores (such as aluminum-bearing ores comprising iron ions) has been a considerable challenge since iron ions are contained in these ores and it can be difficult to separate them from aluminum ions in a simple and cost effective manner.

There is thus a need for providing an alternative method for separating iron ions from aluminum ions. There is thus also a need for treating compositions comprising iron ions and aluminum ions. There is also a need for providing a method that would overcome at least one drawback from the prior art methods.

### SUMMARY OF THE DISCLOSURE

According to one aspect, there is provided a method for separating iron ions from aluminum ions contained in an acidic composition, the method comprising:
reacting the acidic composition with a basic aqueous composition having a pH of at least 10.5 so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion; and
separating the liquid portion from the solid portion.

According to another aspect, there is provided a method for separating iron ions from aluminum ions contained in an acidic composition, the method comprising:
reacting the acidic composition with a base so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion; and
separating the liquid portion from the solid portion.

According to another aspect, there is provided a method for treating an acidic composition comprising iron ions and aluminum ions, the method comprising:
reacting the acidic composition with a basic aqueous composition so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

According to another aspect, there is provided a method for treating an acidic composition comprising iron ions and aluminum ions, the method comprising:
reacting the acidic composition with a base so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

According to another aspect, there is provided a method for separating iron ions from aluminum ions contained in a composition, the method comprising:
reacting the composition with a basic aqueous composition having a pH of at least 10.5 so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion; and
separating the liquid portion from the solid portion.

According to another aspect, there is provided a method for separating iron ions from aluminum ions contained in a composition, the method comprising:
reacting the composition with a base so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion; and
separating the liquid portion from the solid portion.

According to another aspect, there is provided a method for treating a composition comprising iron ions and aluminum ions, the method comprising:
reacting the composition with a basic aqueous so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

According to another aspect, there is provided a method for treating a composition comprising iron ions and aluminum ions, the method comprising:
reacting the composition with a base so as to obtain a precipitation composition, maintaining the precipitation composition at a pH above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

### BRIEF DESCRIPTION OF DRAWINGS

In the following drawings, which represent by way of example only, various embodiments of the disclosure:

FIG. 1 shows a bloc diagram of an example of process according to the present disclosure;

FIG. 2 shows a bloc diagram of another example of process according to the present disclosure;

FIG. 3 shows a bloc diagram of still another example of process according to the present disclosure; and

FIG. 4 shows a bloc diagram of still a further example of process according to the present disclosure.

### DETAILED DESCRIPTION OF VARIOUS EMBODIMENTS

Further features and advantages will become more readily apparent from the following description of various embodiments as illustrated by way of examples only and in a non-limitative manner.

The expression “at least substantially preventing precipitation of the aluminum ions” as used herein refers to the fact that less than about 20%, less than about 10%, less than about 5%, less than about 3%, less than about 2% or less than about 1% of the aluminum ions are precipitated.

The term “hematite” as used herein refers, for example, to a compound comprising α-Fe₂O₃, γ-Fe₂O₃, β-FeO.OH or mixtures thereof.

The expression “iron ions” as used herein refers, for example to ions comprising to at least one type of iron ion chosen from all possible forms of Fe ions. For example, the at least one type of iron ion can be Fe²⁺, Fe³⁺, or a mixture thereof.

The expression “aluminum ions” as used herein refers, for example to ions comprising to at least one type of aluminum ion chosen from all possible forms of Al ions. For example, the at least one type of aluminum ion can be Al³⁺.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The expression “is maintained” as used herein when referring to a value of a pH or a pH range of the precipitation composition refers to maintaining the value of the pH or the pH range at least 75, 80, 85, 90, 95, 96, 97, 98 or 99% of the time during the reaction between the acidic composition and the basic aqueous composition or the reaction between the acidic composition and the base.

The expression “maintaining the precipitation composition at” as used herein when referring to a value of a pH or a pH range, refers to maintaining the value of the pH or the pH range of the precipitation composition at least 75, 80, 85, 90, 95, 96, 97, 98 or 99% of the time during the reaction between the acidic composition and the basic aqueous composition or the reaction between the acidic composition and the base.

The expression “is maintained” as used herein when referring to a value of a temperature or a temperature range of the precipitation composition refers to maintaining the value of the temperature or the temperature range at least 75, 80, 85, 90, 95, 96, 97, 98 or 99% of the time during the reaction between the acidic composition and the basic aqueous composition or the reaction between the acidic composition and the base.

The expression “is maintained” as used herein when referring to a value of a pH or a pH range of the precipitation composition refers to maintaining the value of the pH or the pH range at least 75, 80, 85, 90, 95, 96, 97, 98 or 99% of the time during the reaction between the composition and the basic aqueous composition or the reaction between the composition and the base.

The expression “maintaining the precipitation composition at” as used herein when referring to a value of a pH or a pH range, refers to maintaining the value of the pH or the pH range of the precipitation composition at least 75, 80, 85, 90, 95, 96, 97, 98 or 99% of the time during the reaction between the composition and the basic aqueous composition or the reaction between the composition and the base.

The expression “is maintained” as used herein when referring to a value of a temperature or a temperature range of the precipitation composition refers to maintaining the value of the temperature or the temperature range at least 75, 80, 85, 90, 95, 96, 97, 98 or 99% of the time during the reaction between the composition and the basic aqueous composition or the reaction between the composition and the base.

For example, the method can comprise:

obtaining the acidic composition comprising the aluminum ions and the iron ions;
adding the acidic composition into the basic aqueous composition having a pH of at least 10.5 so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion; and
separating the liquid portion from the solid portion.

For example, the method can comprise:
obtaining the acidic composition comprising the aluminum ions and the iron ions;
adding the acidic composition into the basic aqueous composition having a pH of at least 10.5 so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

For example, the method can comprise:
obtaining the acidic composition comprising the aluminum ions and the iron ions;
adding the acidic composition into the base so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion; and
separating the liquid portion from the solid portion.

For example, reacting the acidic composition with the basic aqueous composition is carried out by adding the acidic composition into the basic composition while maintaining the pH of the basic aqueous composition above 10.5 by adding a further amount of base while adding the acidic composition into the basic aqueous composition.

For example, reacting the acidic composition with the base is carried out by adding the acidic composition into the base while maintaining the pH of the precipitation composition above 10.5 by adding a further amount of base while adding the acidic composition.

For example, the acidic composition and the basic aqueous composition can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

For example, the acidic composition and the base can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

For example, the acidic composition and the basic aqueous composition can be added simultaneously into a reactor so as to be reacted together and to obtain the precipitation composition, the reactor having previously been provided with a quantity of the precipitation composition.

For example, the acidic composition and the basic aqueous composition can be added simultaneously into a reactor so as to be reacted together and to obtain the precipitation composition, the reactor having previously been provided with a quantity of the basic aqueous composition.

For example, the acidic composition and the base can be added simultaneously into a reactor so as to be reacted together and to obtain the precipitation composition, the reactor having previously been provided with a quantity of the precipitation composition.

For example, the acidic composition and the base can be added simultaneously into a reactor so as to be reacted together and to obtain the precipitation composition, the reactor having previously been provided with a quantity of the base.

For example, maintaining the pH of the basic aqueous composition above 10.5 can be carried out by adding a further amount of base while adding the acidic composition into the reactor.

For example, maintaining the pH of the precipitation composition above 10.5 is carried out by adding a further amount of base while adding the acidic composition into the reactor.

For example, the acidic composition can be an acidic leaching composition.

For example, the acidic leaching composition can be obtained by leaching an aluminum-bearing ore that comprises iron with at least one acid so as to obtain a leachate and a solid residue and by substantially isolating the leachate. For example, a filtration, decantation, centrifugation etc. can be done.

For example, the method can comprise:

obtaining the composition comprising the aluminum ions and the iron ions;
adding the composition into the basic aqueous composition having a pH of at least 10.5 so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion; and
separating the liquid portion from the solid portion.

For example, the method can comprise:
obtaining the composition comprising the aluminum ions and the iron ions;
adding the composition into the basic aqueous composition having a pH of at least 10.5 so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion;
separating the liquid portion from the solid portion; and
precipitating the aluminum ions from the liquid portion.

For example, the method can comprise:
obtaining the composition comprising the aluminum ions and the iron ions;
adding the composition into the base so as to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion; and
separating the liquid portion from the solid portion.

For example, reacting the composition with the basic aqueous composition is carried out by adding the composition into the basic composition while maintaining the pH of the basic aqueous composition above 10.5 by adding a further amount of base while adding the composition into the basic aqueous composition.

For example, reacting the composition with the base is carried out by adding the composition into the base while maintaining the pH of the precipitation composition above 10.5 by adding a further amount of base while adding the composition.

For example, the composition and the basic aqueous composition can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

For example, the composition and the base can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

For example, the composition and the basic aqueous composition can be added simultaneously into a reactor so as to be reacted together and to obtain the precipitation composition, the reactor having previously been provided with a quantity of the precipitation composition.

For example, the composition and the basic aqueous composition can be added simultaneously into a reactor so as to be reacted together and to obtain the precipitation composition, the reactor having previously been provided with a quantity of the basic aqueous composition.

For example, the composition and the base can be added simultaneously into a reactor so as to be reacted together and to obtain the precipitation composition, the reactor having previously been provided with a quantity of the precipitation composition.

For example, the composition and the base can be added simultaneously into a reactor so as to be reacted together and to obtain the precipitation composition, the reactor having previously been provided with a quantity of the base.

For example, maintaining the pH of the basic aqueous composition above 10.5 can be carried out by adding a further amount of base while adding the composition into the reactor.

For example, maintaining the pH of the precipitation composition above 10.5 is carried out by adding a further amount of base while adding the composition into the reactor.

For example, the composition can be an acidic leaching composition.

For example, the acidic leaching composition can be obtained by leaching an aluminum-bearing ore that comprises iron with at least one acid so as to obtain a leachate and a solid residue and by substantially isolating the leachate. For example, a filtration, decantation, centrifugation etc. can be done.

The acid used for leaching can be HCl, H₂SO₄, HNO₃ or mixtures thereof. For example, HCl can be used. More than one acid can be used as a mixture or separately. Solutions made with these acids can be used at various concentration. For example, concentrated solutions can be used. For example, 6 M or 12 M HCl can be used. For example, up to 100% wt H₂SO₄ can be used.

The leaching can be carried out under pressure. For example, the pressure can be about 10 to about 300 psig, about 25 to about 250 psig, about 50 to about 200 psig or about 50 to about 150 psig. The leaching can be carried out for about 30 minutes to about 5 hours. It can be carried out at a temperature of about 60 to about 300° C., about 75 to about 275° C. or about 100 to about 250° C.

For example, the precipitation composition can be maintained at a pH of at least about 11.0, at least about 11.5, at least about 12.0, about 10.5 to about 14.5, about 10.5 to about 11.0, about 11.0 to about 14.0, about 11.0 to about 13.0, or about 11.0 to about 12.0.

For example, the precipitation composition can be maintained at a pH of about 10.8 to about 11.8, about 11 to about 12, about 11.5 to about 12.5, about 11.0 to about 11.6, about 11.2 to about 11.5, about 10.5 to about 12, about 11.5 to about 12.5, or about 11.8 to about 12.2, about 11.0, about 11.1, about 11.2, about 11.3, about 11.4, about 11.5, about 11.6, about 11.7, about 11.8, about 11.9, or about 12.0.

For example, the precipitation composition can be maintained at a pH comprised between 10.5 and 14.0; 10.5 and 13.0; 10.5 and 12.0; 10.5 and 11.5; or 10.5 and 11.

For example, addition of the acidic composition into the basic aqueous composition can be carried out by maintaining the pH of the basic composition above 10.5 by adding a further amount of base while adding the acidic composition into the basic aqueous composition.

For example, addition of the composition into the basic aqueous composition can be carried out by maintaining the pH of the basic composition above 10.5 by adding a further amount of base while adding the composition into the basic aqueous composition.

For example, the base can comprise KOH, NaOH, Ca(OH)₂, CaO, MgO, Mg(OH)₂, CaCO₃, Na₂CO₃, NaHCO₃, or mixtures thereof.

For example, the base can comprise KOH, NaOH, or a mixture thereof.

For example, the basic aqueous composition can comprise KOH, NaOH, Ca(OH)₂, CaO, MgO, Mg(OH)₂, CaCO₃, Na₂CO₃, NaHCO₃, or mixtures thereof.

For example, the basic aqueous composition can comprise KOH, NaOH, or a mixture thereof.

For example, the acidic composition and the basic aqueous composition can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

For example, the composition and the basic aqueous composition can be added simultaneously into a reactor so as to be reacted together and to obtain the precipitation composition while maintaining the pH of the precipitation composition above 10.5 so as to cause precipitation of the iron ions, at least substantially preventing precipitation of the aluminum ions, and to obtain a mixture comprising a liquid portion and a solid portion.

The basic aqueous composition can comprise KOH, NaOH, Ca(OH)₂, CaO, MgO, Mg(OH)₂, CaCO₃, Na₂CO₃, NaHCO₃, or mixtures thereof.

For example, the basic aqueous composition can comprise KOH, NaOH or a mixture thereof.

For example, the basic aqueous composition and the acidic composition can be added in a volume:volume proportion of about 1:2 to about 1:6, about 1:3 to about 1:5, or about 1:3 to about 1:4.

For example, the basic aqueous composition and the composition can be added in a volume:volume proportion of about 1:2 to about 1:6, about 1:3 to about 1:5, or about 1:3 to about 1:4.

For example, the acidic composition, prior to be reacted with the basic aqueous composition, can have a pH of about 1 to about 3, about 1.5 to about 2.5, or about 1.8 to about 2.2.

For example, the acidic composition, prior to be reacted with the base, can have a pH of about 1 to about 3, about 1.5 to about 2.5, or about 1.8 to about 2.2.

The basic aqueous composition, prior to be reacted with the acidic composition, can have a pH of about 11 to about 15, about 12 to about 14, or about 13 to about 14. The basic aqueous composition can have a concentration of about 10 to about 25 M, about 15 to about 20 M or about 19 to about 20 M.

The basic aqueous composition, prior to be reacted with the composition, can have a pH of about 11 to about 15, about 12 to about 14, or about 13 to about 14. The basic aqueous composition can have a concentration of about 10 to about 25 M, about 15 to about 20 M or about 19 to about 20 M.

For example, the precipitated iron ions can be recovered.

For example, the precipitated iron ions can be chosen from Fe³⁺, Fe²⁺, and a mixture thereof.

For example, the precipitated iron ions can be under the form of Fe(OH)₂, Fe(OH)₃), or a mixture thereof.

For example, the precipitated iron ions can be under the form of hematite.

For example, the predetermined quantity of hematite can be added to the mixture comprising the liquid portion and the solid portion. For example, this can be made over a predetermined period of time and optionally under agitation.

For example, the predetermined quantity of hematite can be added at a molar ratio hematite/iron ions of about 0.005 to about 0.5 or about 0.01 to about 0.1.

For example, the precipitation composition can be maintained at a temperature of about 50° C. to about 110° C., about 60° C. to about 90° C., about 65° C. to about 85° C., about 70° C. to about 75° C., about 75° C. to about 110° C., about 80° C. to about 100° C., about 85° C. to about 95° C. or about 87° C. to about 93° C.

The aluminum-bearing material that comprises iron can be an aluminium-bearing ore that comprises iron. For example, clays, argillite, mudstone, beryl, cryolite, garnet, spinel, bauxite, or mixtures thereof can be used as starting material. For example, the aluminum-bearing ore can be argillite. The aluminum-containing material can also be a recycled industrial aluminum-bearing material such as slag. The aluminum-bearing material can also be red mud or fly ashes.

For example, iron ions can be precipitated. When precipitating iron ions, the iron ions can be precipitated by means of an ionic precipitation and they can precipitate in the form of various salts, hydroxides or hydrates thereof. For example, the iron ions can be precipitated as Fe(OH)₃, Fe(OH)₂, hematite, geotite, jarosite or hydrates thereof.

The leaching can be carried out at a pH of about 0.5 to about 2.5., about 0.5 to about 1.5, or about 1; then iron can be precipitated at a pH of at least about 10.5, 11, 11.5, 12.0; then aluminum can be precipitated at a pH of about 7 to about 11, about 7.5 to about 10.5, or about 8 to about 9.

The leaching can be carried out under pressure into an autoclave. For example, it can be carried out at a pressure of 5 KPa to about 850 KPa, 50 KPa to about 800 KPa, 100 KPa to about 750 KPa, 150 KPa to about 700 KPa, 200 KPa to about 600 KPa, or 250 KPa to about 500 KPa. The leaching can be carried out at a temperature of at least 80° C., at least 90° C., or about 100° C. to about 110° C. In certain cases it can be done at higher temperatures so as to increase extraction yields in certain ores.

For example, the aluminum ions can be recovered.

For example, aluminum ions (from the liquid portion) can be precipitated. When precipitating aluminum ions, the aluminum ions can be precipitated by means of an ionic precipitation and they can precipitate in the form of various salts, (such as chlorides, sulfates, hydroxides, or hydrates thereof). For example, the aluminum ions can be precipitated as Al(OH)₃, AlCl₃, Al₂(SO₄)₃, or hydrates thereof.

For example, the methods can further comprise precipitating the aluminum ions from the liquid portion by adjusting the pH at a value of about 7 to about 11, about 8 to about 10.5, about 8.5 to about 10, about 9 to about 10, or about 9.2 to about 9.8.

The methods can further comprise adding a precipitating agent effective for facilitating precipitation of the aluminum ions. For example, the precipitating agent can be a polymer. For example, the precipitating agent can be an acrylamide polymer.

For example, precipitated aluminium ions can be converted into alumina by means of a calcination. Such a step can be carried out by calcination. Al(OH)₃ can then be converted into Al₂O₃. Such a conversion of Al(OH)₃ into Al₂O₃ can be carried out at a temperature of about 800° C. to about 1200° C. For example, it can be carried out as indicated in WO 2008141423 that is hereby integrated by reference in its entirety. Thus, the person skilled in the art would clearly understand how to convert Al(OH)₃ into Al₂O₃.

For example, the methods can further comprise converting alumina (Al₂O₃) into aluminum. Conversion of alumina into aluminum can be carried out, for example, by using the Hall-Héroult process. References is made to such a well known process in various patents and patent applications such as US 20100065435; US 20020056650; U.S. Pat. No. 5,876,584; U.S. Pat. No. 6,565,733. Conversion can also be carried out by means of other methods such as those described in U.S. Pat. No. 7,867,373; U.S. Pat. No. 4,265,716; U.S. Pat. No. 6,565,733 (converting alumina into aluminum sulfide followed by the conversion of aluminum sulfide into aluminum.) These documents are also hereby integrated by reference in their entirety. Thus, the person skilled in the art would clearly understand how to convert Al₂O₃ into aluminum.

For example, Al(OH)₃ can be converted into AlCl₃. This can be done, for example, by reacting Al(OH)₃ with HCl.

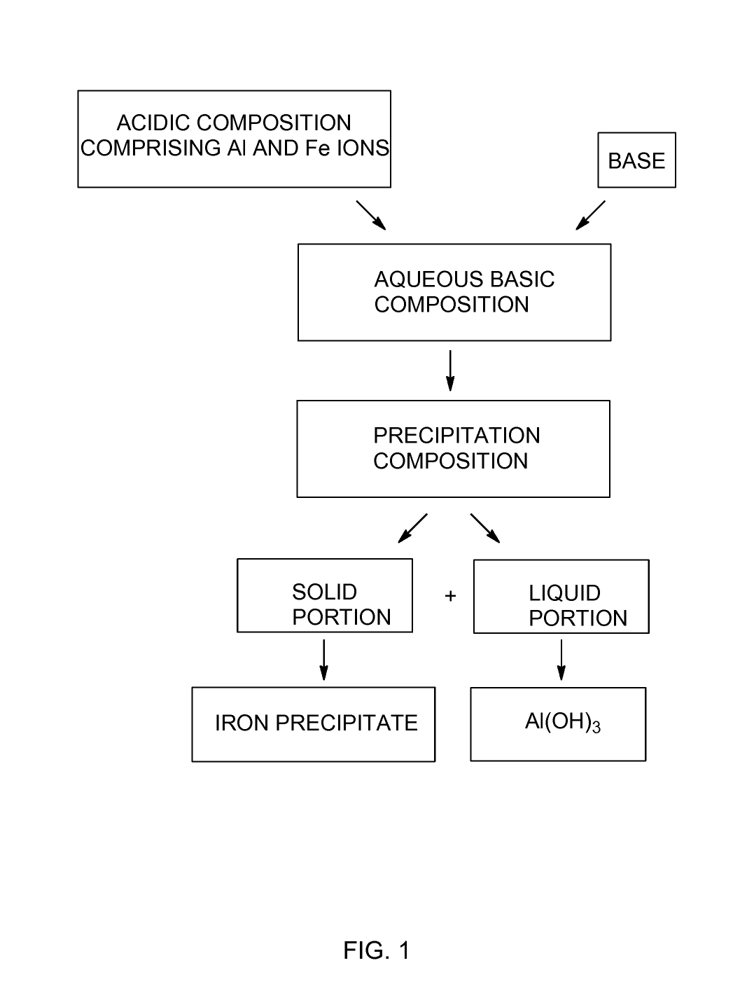

As it can be seen from FIGS. 1 to 4, there are provided various different example of methods as described in the present disclosure.

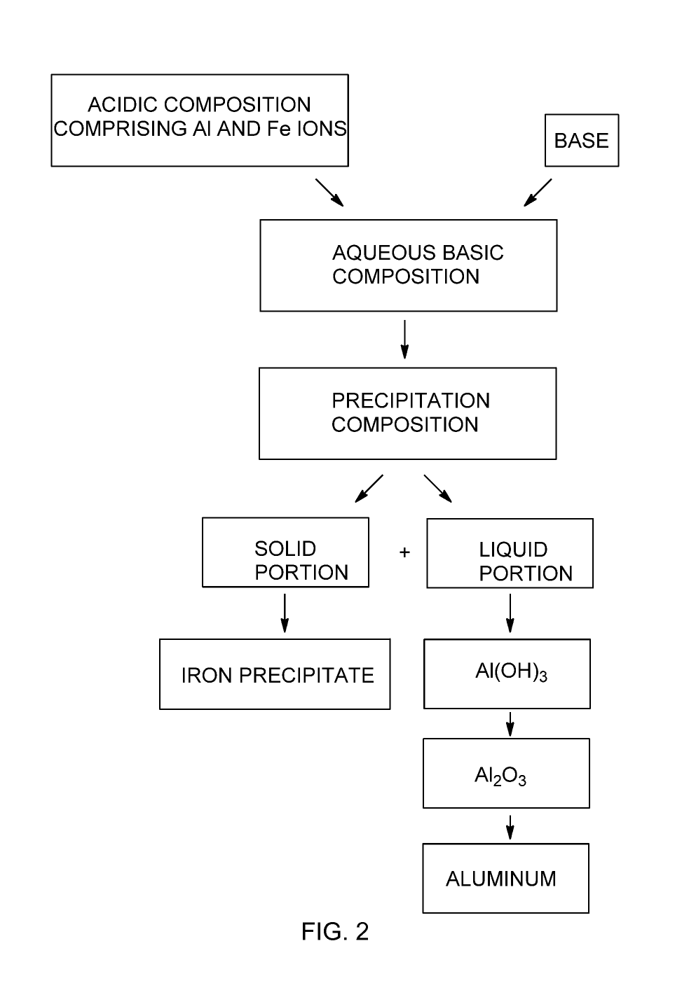

FIGS. 1 and 2 show two methods that are similar, with the exception that the method shown in FIG. 2 comprises the conversion of Al(OH)₃ into alumina (Al₂O₃) and then, the conversion of alumina into aluminum.

In the methods of FIGS. 1 and 2, it can be seen that the acid composition is added into a reactor or container comprising the aqueous basic composition. Then, the mixture obtained by reacting together the acidic composition and the aqueous basic composition i.e. the precipitation composition, will be eventually treated for separating the solid portion for the liquid portion (for example by means of a solid/liquid separation). For example, when adding the acidic composition into the reactor, a base can be added simultaneously so as to maintain the pH of the aqueous basic composition and/or the pH of the precipitation composition above 10.5. It should also be noted that the base can also be added before and/or after adding the acidic composition. Periodic additions of base can also be made.

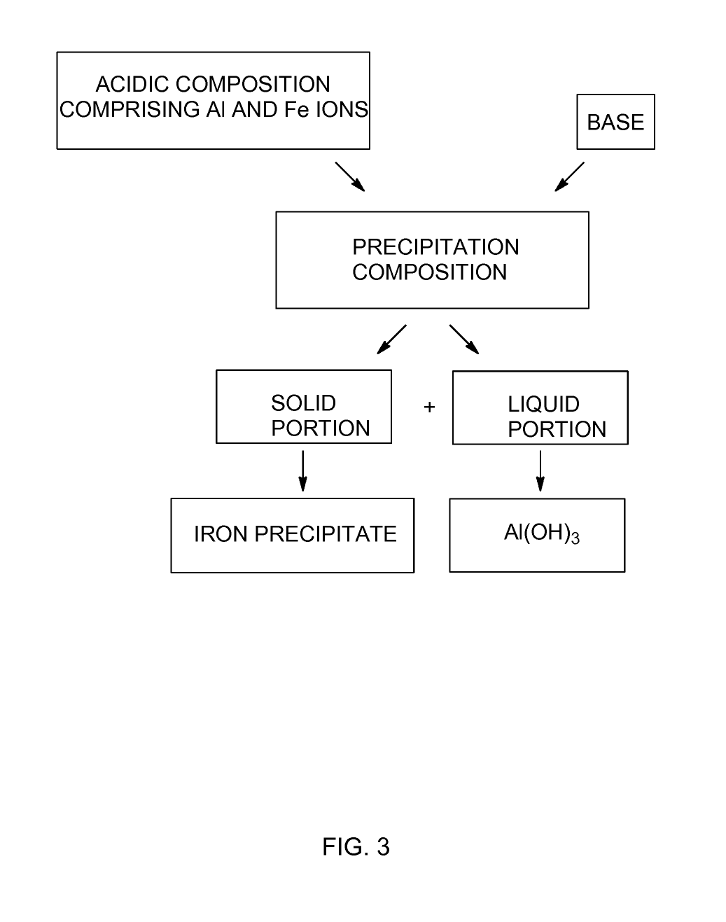

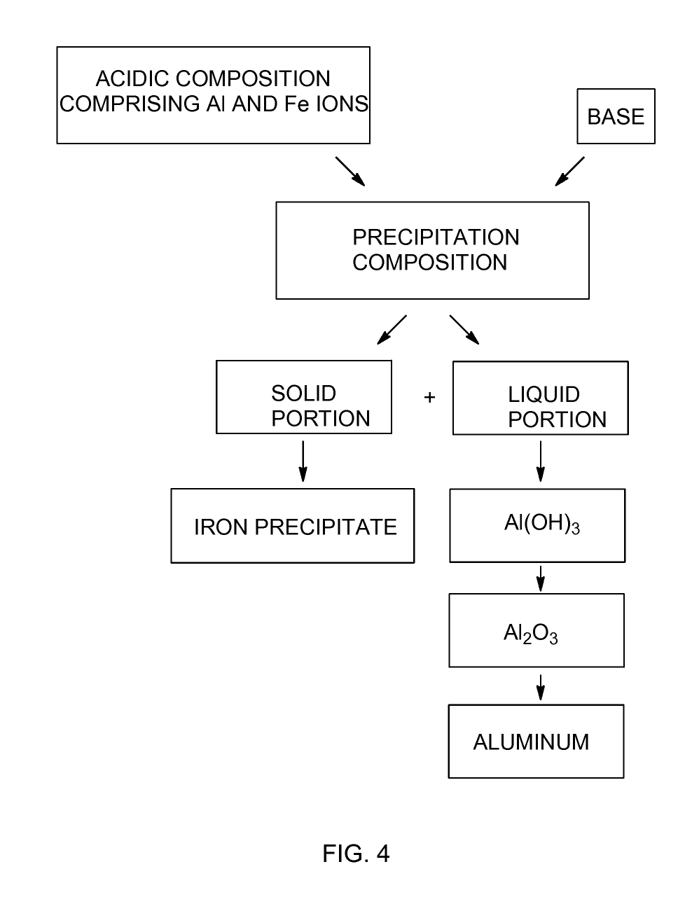

In the methods of FIGS. 3 and 4, it can be seen that the acidic composition can be added in a reactor simultaneously with a base so as to obtain the precipitation composition. The acidic composition can also be added in a reactor that already comprises a base. A further quantity of base can also be added simultaneously with the addition of the acidic composition into the reactor. As previously explained, the addition of the base will allow for maintaining the pH of the precipitation composition above 10.5. Alternatively, the acidic composition can be added simultaneously with the base in an empty reactor. In such a case, it is possible to adjust the flow of the two reactants so as to maintain the pH as indicated above. FIGS. 3 and 4 show two methods that are similar, with the exception that the method shown in FIG. 4 comprises the conversion of Al(OH)₃ into alumina (Al₂O₃) and then, the conversion of alumina into aluminum.

As discussed in the present disclosure, the iron precipitate shown in FIGS. 1 to 4 can be of various forms. For example, it can comprise Fe(OH)₂, Fe(OH)₃, hematite or mixtures thereof. The iron precipitate can comprise Fe(OH)₂ and/or Fe(OH)₃, and such a precipitate can then be converted into hematite as described in the present application.

It should also be noted that according to other examples of the present disclosure, methods represented in FIGS. 1 to 4 can also use, as starting material, any compositions that comprise aluminum ions and iron ions. Such compositions can be substantially neutral or basic (for example red mud).

In FIGS. 1 to 4, the base added into the aqueous basic composition or into the precipitation composition can be under the form of an aqueous composition of in a solid form. For example, the base can be added into a reactor or combined with the acidic composition before being added to the reactor.

### Example 1

### Treating an Aluminum-Bearing Ore Sample Comprising Iron Ions

The aluminum-bearing ore (for example argillite) can be activated mechanically by grinding. Mineral activation leads to a positive influence on the leaching reaction kinetics. For example, a ball mill can be used in air atmosphere for about 2 to 4 hours. Argillite can be also calcinated. This stage of pretreatment can be accomplished at a calcinating temperature between about 400 to about 700° C. for a period about 1 to about 2 hours. These two operations, for example, increase the quantity of extracted aluminum by about 25 to 40%.

### Acid Leaching

Acid leaching can be made by mixing activated argillite with an acid solution (for example HCl) at elevated temperature and under pressure during a given period of time. For example, the argillite/acid ratio can be of about of 1:3 (weight/volume), the concentration of about 6M, the pressure can be of about 70 to about 80 psi, the temperature can be of about 150 to about 170° C., and the reaction time can be about 1 hour to about 7 hours. Under these conditions, over 90% of aluminum and 100% of the iron can be extracted besides the impurities.

At the end of extraction, the solid (non-dissolved portion) can be separated from the liquid rich aluminum and iron by decantation or by filtration, after which is washed. This solid represent about 50 to about 60% of the initial mass of argillite. It can be valorized and be used as constituent alloy.

Separating Aluminum Ions from Iron Ions (Removal of Iron)

The iron contained in the solution can be removed by selectively precipitating it at certain pH values. For example, iron removal can be carried out by precipitation in a basic medium at a pH greater than about 11.0 or 11.2. This stage can be made by reacting the acidic composition (pH of about 2) containing aluminum and iron ions in a basic aqueous composition (see FIG. 1), for example NaOH at a concentration of about 19.0 to about 19.5 M and pH of about 13.5 to about 14.0. The acidic composition and the basic aqueous composition can be added simultaneously in a reactor, under agitation at atmospheric pressure, so as to obtain a precipitation composition that is maintained at a temperature of about 70 to about 90° C. This can be done for example due to the exothermicity of the chemical reaction. Other bases such as KOH can also be used. Iron can thus be precipitated under the form of compounds such as Fe(OH)₂ and/or Fe(OH)₃ (see FIG. 1). The volume:volume proportion of basic aqueous composition:acidic composition can be about 1:3 to about 1:4.

Hematite can also be added (can be called seeding hematite) to the precipitation reaction. Hematite seed addition can enhance hematite precipitation reaction (for example transformation of Fe(OH)₂ and/or Fe(OH)₃) into hematite). For example, hematite can be added in a proportion of 10 g for 1L of precipitation composition optionally under agitation. The reaction temperature can be of about 70° C. to about 90° C. (for example, the precipitation composition can be at such a temperature), and the reaction time can be of about 3 hours to about 72 hours. Under such conditions, about 98% to about 100% of iron can be precipitated and about 70% to 100% of this iron can be precipitated as hematite. Optionally, it is possible to recover iron by using a refining step by liquid-liquid extraction for example, through a hollow fiber membrane.

It is possible to separate the solid portion from the liquid portion by filtration, decantation or centrifugation and to rinse the solid by means of a diluted base, such as a solution of NaOH (for example NaOH at a concentration of 1M to 2M). At the end of this step, the solid can be washed with water.

### Aluminum Recovery

This step can also be carried in various ways. Aluminum ions can be precipitated under the form of aluminum hydroxide. For example, an hydrated form of Al(OH)₃ can be obtained (by addition of an acid) at a pH of about 7 to about 10.5 or about 7.5 to about 10 or about 9. The temperature can be of about 50° C. to about 80° C., and the reaction time can be of about 3 hours to about 24 hours. This step can be made by adding a solution of HCl, for example at a concentration of 6M. Other acids can also be used. From the previous step, for example 90 to 100% aluminum hydroxide can be precipitated.

Alternatively, aluminum ions can be precipitated by addition of an acidic gas. For example, an hydrated form of Al(OH)₃ sprayed by CO₂, at a pH of about 7 to about 10.5, the temperature can be of 50° C. to 80° C., and the reaction time can be of about 3 hours to about 24 hours. From the previous step, for example 90 to 100% aluminum hydroxide can be precipitated.

Another way of precipitating aluminum ions can be carried out by addition of a flocculating agent. Various flocculating agents can help to the formation of voluminous flakes which settles by sedimentation. For example, an acrylamide polymer can be used, at a concentration of about 0.1% to about 0.3%. The ratio flocculating agent/solution of hydroxide aluminum can be about 1:300 (volume/volume). The temperature can be below 30° C. and the reaction time can be of about 5 minutes to about 20 minutes. Under such conditions, more than about 97% of the aluminum can be precipitated.

### Example 2

### Treating an Aluminum-Bearing Ore Sample Comprising Iron Ions Argillite

The argillite was ground up in the wet phase in a ball grinder. The mixture of water and roughly crushed argillite coming from the mine was fed into the grinder, where the mineral is reduced to less than 100 microns. The mud went down by gravity into a mixer outfitted with two impellers, which ensures a good homogeneity. When the mixture reaches the desired density, the contents of the mixer are pumped to an accumulation bunker, which will serve to feed the mud to an autoclave.

### Acid

The acid fed to the leaching came from two sources. The major portion was recycled spent acid. This recycled acid contained about 20 to about 22 wt. % of hydrochloric acid (HCl) and about 10 to about 11% of AlCl₃. For example, if excess acid is required, a small quantity of fresh 36% acid can be used.

### Leaching

The mud of argillite and acid were fed to the autoclave of 32 m³ in stoichiometric proportion. The autoclave was then hermetically sealed, mixed well and heated by indirect contact with the steam-fed jacket. As the temperature was rising, the steam pressure increased such that the reaction reached a temperature of about 175° C. and a pressure of about 7.5 barg. At the end of the leaching cycle, the metals contained in the argillite were converted into chlorides. The mixture was then cooled by indirect contact with the cooling water in the reactor jacket. When the mixture was at about 70 to about 80° C., the leached mud was transferred by air pressure to two buffer reservoirs maintained in communicating vessels for further treatment and disposal and the leachate was thus ready for further treatments.

### Preparation of Hematite

The mother liquor from leaching (leachate) was pumped at constant rate across cartridge filters to the first iron precipitation reactor. This reservoir was well mixed and the temperature was controlled to about 65 to 70° C. by means of a heating coil. The pH was continuously metered and the solution was maintained at a pH of about 12 by addition of 50 wt % caustic soda with the help of a dispensing pump (see FIGS. 1 and 2) The precipitation reaction converted the iron chloride and the other metal chlorides into hydroxides, which were leading to a gradual precipitation and agglomeration of the solid crystals. The leachate was then fed consecutively to two other precipitation reactors when the pH was also controlled by the addition of caustic soda and the temperature maintained by a heating coil. At the exit from the last reactor, the liquor was fed to a gravity decanter.

### Decanting and Seeding

The purpose of the gravity decanter was to produce a thickened mud of the largest crystals of hematite. These crystals served for the seeding in the first precipitation reactor. It was observed that such a technique was useful to promote the creation of precipitates (hematite) that are larger and more easy to filter. A quantity of about 1.5 to about 5.5 g of hematite per liter of the solution was used for seeding. The concentration of Fe in the solution was about 2.5 to about 3.0 g/L.

### Filtration of Hematite

The filtration of the hematite was carried out with the help of two automated filter presses. The mother liquor was then sent to a buffer reservoir to be pumped to the aluminum precipitation reactor.

### Neutralization of Hematite

The washed hematite was sent to a blade mixer where the pH of the solid is metered. A pH less than about 8 was maintained by the addition of hydrochloric acid (HCl) with the help of a dispensing pump.

### Precipitation of Aluminum

For the precipitation of the aluminum, the pH of the mother liquor was adjusted to about 9.5 by reacting it with HCl. Since the mother liquor has been purified of all other metals, the obtained precipitate was white and with purity of at least 98.5%.

The mother liquor was pumped at constant rate across guard filters to the first main reactor for precipitation of aluminum hydroxide. This reservoir was maintained in suspension by an impeller and the temperature was controlled at 65° C. with the help of a heating coil. The pH was metered continuously and the solution was maintained at pH of about 9.5 by addition of HCl using a dispensing pump. The precipitation reaction was effective for converting the aluminum chloride into aluminum hydroxide, which resulted in a gradual precipitation and agglomeration of solid crystals. The liquor was then sent consecutively to two other precipitation reactors where the pH was also controlled by the adding of acid and the temperature maintained by a coil. At the exit from the last reactor, the liquor is fed to a gravity decanter.

### Decanting and Seeding

A gravity decanter was also used to produce a thickened Al(OH)₃ mud of the largest crystals. These crystals were pumped from the bottom of the decanter to the first precipitation reactor to seed the crystallization.

The rest of the Al(OH)₃ mud and the supernatant fluid of the decanter were sent to a repulping tank from which the mixture was pumped to a centrifuge type separator/washer. After the treatment with the separator, the Al(OH)₃ was then dried.

The Applicant hereby submits that the person skilled in the art would clearly understand that the various embodiments presented in paragraphs [013] to [00124], when applicable, can be combined in all possible manners and be applied to the methods recited in paragraphs [005] to [012]. The embodiments of paragraphs [013] to [00124] of the present disclosure are presented in such a manner in the present disclosure so as to demonstrate that every combinations of embodiments, when applicable can be made. These embodiments have thus been presented in a manner equivalent to making dependent claims for all the embodiments that depend upon any of the preceding claims (covering the previously presented embodiments), thereby demonstrating that they can be combined together.

It was found that the methods of the present application allowed for efficiently separate aluminum ions from iron ions. For example, it was observed that such a drastic pH change for the composition (for example acidic composition) allows for causing precipitation of iron ions by substantially preventing precipitation of aluminum ions. In fact, when for example, adding the acidic composition into a reactor containing the basic composition while simultaneously adding some more base to the basic composition, it was observed that a rapid precipitations of the iron ions occurred without however generating a substantial precipitation of the aluminum ions. In fact, this allows for substantially preventing precipitation of the aluminum ions.

While a description was made with particular reference to the specific embodiments, it will be understood that numerous modifications thereto will appear to those skilled in the art. Accordingly, the above description and accompanying drawings should be taken as specific examples and not in a limiting sense.

1. A method for separating iron ions from aluminum ions contained in an acidic composition, said method comprising:
reacting said acidic composition with a basic aqueous composition having a pH of at least 10.5 so as to obtain a precipitation composition, maintaining said precipitation composition at a pH above 10.5 so as to cause precipitation of said iron ions, at least substantially preventing precipitation of said aluminum ions, and to obtain a mixture comprising a liquid portion and a solid portion; and
separating said liquid portion from said solid portion,
wherein reacting said acidic composition with said basic aqueous composition is carried out by adding said acidic composition into said basic composition while maintaining the pH of said basic aqueous composition above 10.5 by adding a further amount of base while adding said acidic composition into said basic aqueous composition.

2. The method of claim 1, wherein said method comprises:
obtaining said acidic composition comprising said aluminum ions and said iron ions;
adding said acidic composition into said basic aqueous composition having a pH of at least 10.5 so as to obtain said precipitation composition while maintaining the pH of said precipitation composition above 10.5 so as to cause precipitation of said iron ions, at least substantially preventing precipitation of said aluminum ions, and to obtain a mixture comprising a liquid portion and a solid portion; and
separating said liquid portion from said solid portion.

3. The method of claim 1, wherein said precipitation composition is maintained at a pH of at least about 11.0.

4. The method of claim 1, wherein said precipitation composition is maintained at a pH of at least about 11.5.

5. The method of claim 1, wherein said precipitation composition is maintained at a pH of at least about 12.0.

6. The method of claim 1, wherein said precipitation composition is maintained at a pH comprised between 10.5 and 14.5.

7. The method of claim 1, wherein said precipitation composition is maintained at a pH of about 11.0 to about 14.0.

8. The method of claim 1, wherein said precipitation composition is maintained at a pH of about 11.0 to about 13.0.

9. The method of claim 1, wherein said precipitation composition is maintained at a pH of about 11.0 to about 12.0.

10. The method of claim 1, wherein said precipitation composition is maintained at a pH comprised between 10.5 and 11.0.

11-13. (canceled)

14. The method of claim 1, wherein said acidic composition and said basic aqueous composition are added simultaneously into a reactor so as to be reacted together and to obtain said precipitation composition while maintaining the pH of said precipitation composition above 10.5 so as to cause precipitation of said iron ions, at least substantially preventing precipitation of said aluminum ions, and to obtain a mixture comprising a liquid portion and a solid portion.

15. The method of claim 14, wherein said acidic composition and said basic aqueous composition are added simultaneously into a reactor so as to be reacted together and to obtain said precipitation composition, said reactor having previously been provided with a quantity of said precipitation composition.

16-22. (canceled)

23. The method of claim 1, wherein said basic aqueous composition and said acidic composition are added in a volume:volume proportion of about 1:3 to about 1:4.

24. The method of claim 23, wherein said acidic composition, prior to be reacted with said basic aqueous composition, has a pH of about 1 to about 3.

25-29. (canceled)

30. The method of claim 24, wherein said acidic leaching composition is obtained by leaching an aluminum-bearing material that is an aluminum-bearing ore is chosen from clays, argillite, mudstone, beryl, cryolite, garnet, spinel, bauxite, and mixtures thereof.

31-38. (canceled)

39. The method of claim 30, wherein said method further comprises reacting said mixture comprising said liquid portion and said solid portion with a predetermined quantity of hematite, thereby promoting, catalyzing and/or enhancing formation of said hematite.

40-41. (canceled)

42. The method of claim 1, wherein said precipitation composition has a temperature of about 65° C. to about 85° C.

43-157. (canceled)

158. A method for separating iron ions from aluminum ions contained in an acidic composition, said method comprising:
reacting said acidic composition with a basic aqueous composition having a pH of at least 10.5 so as to obtain a precipitation composition, maintaining said precipitation composition at a pH above 10.5 so as to cause precipitation of said iron ions, at least substantially preventing precipitation of said aluminum ions, and to obtain a mixture comprising a liquid portion and a solid portion; and
separating said liquid portion from said solid portion,
wherein said acidic composition and said basic aqueous composition are added simultaneously into a reactor so as to be reacted together and to obtain said precipitation composition while maintaining the pH of said precipitation composition above 10.5 so as to cause precipitation of said iron ions, at least substantially preventing precipitation of said aluminum ions, and to obtain a mixture comprising a liquid portion and a solid portion, and
wherein said acidic composition and said basic aqueous composition are added simultaneously into a reactor so as to be reacted together and to obtain said precipitation composition, said reactor having previously been provided with a quantity of said precipitation composition.

159. A method for separating iron ions from aluminum ions contained in an acidic composition, said method comprising:
reacting said acidic composition with a basic aqueous composition having a pH of at least 10.5 so as to obtain a precipitation composition, maintaining said precipitation composition at a pH above 10.5 so as to cause precipitation of said iron ions, at least substantially preventing precipitation of said aluminum ions, and to obtain a mixture comprising a liquid portion and a solid portion; and
separating said liquid portion from said solid portion,
wherein said precipitated iron ions are precipitated under the form of hematite.

160. A method for treating an acidic composition comprising iron ions and aluminum ions, said method comprising:
reacting said acidic composition with a basic aqueous composition having a pH of at least 10.5 so as to obtain a precipitation composition, maintaining said precipitation composition at a pH above 10.5 so as to cause precipitation of said iron ions, at least substantially preventing precipitation of said aluminum ions, and to obtain a mixture comprising a liquid portion and a solid portion;
separating said liquid portion from said solid portion; and
precipitating said aluminum ions from said liquid portion,
wherein said method further comprises reacting said mixture comprising said liquid portion and said solid portion with a predetermined quantity of hematite, thereby promoting, catalyzing and/or enhancing formation of said hematite.
